(19) United States
(12) Patent Application Publication
(10) Pub. No.: US 2025/0001502 A1
(43) Pub. Date: Jan. 2, 2025

(54) DETECTION OF THE OXIDATION PROGRESS OF METAL CONDENSATE

(71) Applicant: EOS GMBH ELECTRO OPTICAL SYSTEMS, Krailling (DE)

(72) Inventors: Ulrich KLEINHANS, Prittriching (DE); Marco ARNOLD, Puchheim (DE); Tobias EBERHORN, München (DE)

(21) Appl. No.: 18/292,891

(22) PCT Filed: Jul. 27, 2022
(86) PCT No.: PCT/EP2022/071031

§ 371 Date: Jan. 26, 2024

(30) Foreign Application Priority Data
Jul. 27, 2021 (DE) 102021208114.2

(51) Int. Cl. B22F 10/77; B22F 10/32; B22F 12/70; B33Y 40/00

(52) U.S. Cl. CPC B22F 10/77; B22F 10/32; B22F 12/70; B33Y 40/00

(57) ABSTRACT

Disclosed is a method of oxidizing welding fume residues of an additive manufacturing apparatus adapted to process a metal-based building material. The additive manufacturing apparatus includes a process chamber for manufacturing a three-dimensional object and a circulation system having a gas circuit for a protective gas which is passed through the process chamber. The welding fume residues are exposed for a passivation time period to a gas atmosphere containing an oxidizing agent in a chamber, where the passivation time period is ended depending on a difference between oxidizing agent concentrations in the chamber detected by at least one sensor at two points in time having a predetermined distance from one another.

The present invention relates to a method of oxidizing welding fume residues of an additive manufacturing apparatus adapted to process a metal-based building material.

Apparatuses and methods for additive manufacturing of three-dimensional objects are used, for example, in rapid prototyping, rapid tooling or additive manufacturing. An example of such a method is known under the name “Selective Laser Sintering or Laser Melting”. In this method, a layer of a building material, usually in powder form, is repeatedly applied and the building material in each layer is selectively solidified by selective irradiation of locations corresponding to the cross section of the object to be manufactured in this layer with a laser beam. Further details are described, for example, in EP 2 978 589 B1.

During the manufacturing process, often a protective gas atmosphere, usually an inert gas atmosphere, is maintained in the process chamber in which the building material is selectively melted by means of radiation. One reason for this is, inter alia, that some building materials, in particular if they contain metal, tend to oxidize at the high temperatures during the melting process, which prevents the formation of objects (for example, titanium could start to burn in an uncontrolled manner) or at least prevents the formation of objects with the desired material structure.

The conditions during the melting process are comparable to those during welding (for example laser welding or electron beam welding). In particular, building material can evaporate as a result of the input radiation energy and can condense as condensate particles upon cooling. Thus, the existing gas atmosphere contains condensate particles. In the present application, such mixture of gas and condensate particles (smallest structures, also called primary particles, with a size of usually below 50 nm) is referred to as welding fume. In addition, the welding fume can also contain further constituents, such as powdered building material (often with particle sizes between 1 and 50 μm) that has been swirled up. In additive manufacturing apparatuses in which the building material is melted by means of radiation, the welding fume can lead to a scattering of the radiation and thus to an impairment of the manufacturing process. Therefore, the protective gas is usually passed as protective gas stream over the construction plane, i.e. the surface of a building material layer to be solidified, in order to remove the welding fume from there.

The welding fume can deposit as residue on the walls of the process chamber and of the pipeline system existing for providing the protective gas atmosphere. Therefore, a filter element for cleaning the gas is usually arranged in the protective gas stream so that welding fume residues are deposited on the filter element. From there, they can be cleaned from time to time by means of a gas pressure surge, as is described, for example, in DE 10 2014 207 160 A1.

In the case of metal-containing or metallic building materials (in particular in the case of titanium or titanium alloys), the condensate particles and powder particles tend to react with oxidative materials, above all at high temperatures, the reaction rate increasing with the temperature. Metal condensate can spontaneously ignite itself at room temperature and in contact with atmospheric oxygen and is therefore usually pyrophoric. As a result, uncontrolled fires or even dust explosions can occur where welding fume residues have accumulated. This risk is increased if sections of the additive manufacturing apparatus are opened and oxygen from ambient air can reach the welding fume residues (for example when the process chamber is opened or when the filter element is changed).

Therefore, the object of the present invention is to provide a method and an apparatus by means of which uncontrolled oxidation reactions on welding fume residues of an additive manufacturing apparatus can be prevented.

This object is achieved by a method according to claims 1 and 7 and an apparatus according to claims 18 and 24. Further developments of the invention are specified in the dependent claims. Here, the method can also be further developed by the features of the apparatuses described below or in the dependent claims or vice versa, and the features of the apparatuses can also be used among each other for a further development.

In an inventive method of oxidizing welding fume residues of an additive manufacturing apparatus adapted to process a metal-based building material,
wherein the additive manufacturing apparatus comprises a process chamber for manufacturing a three-dimensional object and
a circulation system having a gas circuit for a protective gas which is passed through the process chamber,
the welding fume residues are exposed for a passivation time period to a gas atmosphere containing an oxidizing agent in a chamber, wherein the passivation time period is ended depending on a difference between oxidizing agent concentrations in the chamber detected by at least one sensor at two points in time having a predetermined distance from one another.

Additive manufacturing apparatuses to which the invention relates are in particular those which are suitable for the generative manufacturing of three-dimensional objects from a metal-containing building material, in particular those in which the objects are built up layer by layer, meaning for example laser melting and laser sintering apparatuses. In addition, however, a use in other generative apparatuses, which operate at a high process temperature in order to melt building material having a high melting point, for example in laser cladding apparatuses, is also possible. In all cases, instead of an apparatus having a laser, an apparatus in which an electron beam is used to introduce the necessary energy for melting the building material can also be used.

A process chamber is considered to be a section of the manufacturing apparatus in which the additive manufacturing process takes place and which is enclosed by a casing, so that a gas atmosphere different from the one in the surroundings of the manufacturing apparatus can be maintained in its interior. The protective gas in the interior of the process chamber can in particular be an inert gas, i.e. for example nitrogen, helium or argon, wherein the protective gas can also contain mixtures of different chemical elements and the pressure in the process chamber can optionally also be below atmospheric pressure. It is in particular also conceivable that the protective gas comprises further components in addition to inert gases.

When the circulation system is operated, a gas conveying device ensures a continuous flow of protective gas, preferably in a closed gas circuit (disregarding a possible addition of protective gas to compensate for leaks). The flow of protective gas is preferably maintained at least during such periods of time during which building material is melted in the process chamber.

The welding fume residues mentioned and characterized in the introduction, which can react in an uncontrolled manner with an oxidizing agent, in particular with oxygen, according to the invention are passivated by oxidizing them in a controlled manner. For this purpose, the welding fume residues are exposed for a limited period of time, here also referred to as passivation time period, to the gas atmosphere containing the oxidizing agent in a preferably closed chamber, which is in particular closed gas-tight, (this chamber could also be referred to as passivation chamber). The aim of the procedure is not necessarily to ensure an oxidation of the material as complete as possible, even if one can of course strive for this. Rather, a condition shall be achieved in which a sufficient amount of the welding fume residues is partially oxidized at least to the extent that self-ignition is excluded even in contact with air and safe handling is possible. Ideally, the minimum ignition energy (determinable according to EN 13821) should not be less than that of the building material and at the end a combustion factor (determinable according to VDI 2263-1) should be less than or equal to 3.

The oxidizing agent can in particular be oxygen that is a component of a gas supplied to the chamber. The oxygen can exist in the form of O₂, O₃, or other compounds containing oxygen atoms, the oxygen content of which can act as an oxidizing agent. It is possible here that the gas containing oxidizing agent is supplied to the chamber while keeping constant the content of the oxidizing agent content in the gas. However, it is also possible to proceed in such a way that the oxidizing agent content is increased continuously or in stages and/or decreased continuously or in stages. As the case may be, it is also possible to enrich a gas atmosphere in the chamber by supplying pure oxygen. When in the present application reference is made to oxygen, it is evident that the same can exist in the above-mentioned configurations or else can be replaced by another oxidizing agent.

Furthermore, a passivation process according to the invention can also be carried out several times in succession in the chamber.

In particular, the oxidation reaction can be initiated by supplying energy. For example, a piezo element, a radiant heater or else a heating device such as a resistance heating, can be used as energy supply means for heating the gas which is supplied to the chamber and which contains the oxidizing agent. It should be noted that not only the start but also the progress of the oxidation reaction can be promoted by increasing the temperature (for example by heating the chamber to 300° C.), although it is of course also possible to operate at room temperature.

The oxidizing agent concentration in the chamber can be detected by a sensor sensitive to the oxidizing agent, for example a sensor suitable for determining the concentration of gaseous oxygen. For example, paramagnetic sensors or lambda probes/Nernst probes can be used as sensors. As an alternative to the oxidizing agent concentration (in % by volume), for example an oxidizing agent partial pressure or else the total pressure in the chamber (which decreases with decreasing oxidizing agent concentration in the chamber atmosphere when the gas supply is interrupted) can also be detected. In particular, also a plurality of sensors, which are arranged in the chamber, upstream of the chamber, for example in gas supply lines to the chamber, or downstream of the chamber, for example in gas discharge lines from the chamber, can be present. The terms “upstream” and “downstream” relate here to the direction of a gas flow with which the gas containing the oxidizing agent is supplied to the chamber.

In the case of the presence of a plurality of sensors, an oxidizing agent concentration in the chamber can be detected for example by forming a mean value of the values supplied by the individual sensors at a specific point in time. Optionally, also the formation of a weighted mean value is possible, wherein the weighting then depends on the position of the sensors.

In the procedure according to the invention, the length of the passivation time period is controlled depending on the change of the oxidizing agent concentration in the chamber, which is determined by means of the at least one sensor. Thereby, the progress of an oxidation process of the filter residues can be actively monitored. In particular, the passivation time period is not ended in dependence of an absolute value of the oxidizing agent concentration in the chamber. If the temporal behaviour of the oxidizing agent concentration in the chamber is determined and the passivation time period is ended in dependence thereof, the length of the passivation time period can be precisely controlled. On the one hand, relative changes of the oxidizing agent concentration can be determined with higher accuracy than absolute values of the oxidizing agent concentration. In particular, the determination of the change of the oxidizing agent concentration is often simpler than the determination of its absolute value, for example in that the change of the oxidizing agent concentration is inferred from a change of the pressure in the chamber. Another aspect is that the measurement effort can be reduced in that temporal changes can be extrapolated.

As follows from the above, the passivation time period is not a time period whose length is predetermined already at the start. Rather, only the start of the passivation time period is predetermined, for example by predetermining specific criteria which must be fulfilled. One criterion can be, for example, the reaching of a specific oxidizing agent concentration in the gas atmosphere of the chamber after the start of the supply of gas containing the oxidizing agent. The temporal end of the passivation time period depends on the values of the oxidizing agent concentration determined by the at least one sensor.

The change of the oxidizing agent concentration in the chamber is determined on the basis of the difference between oxidizing agent concentrations in the chamber detected at two points in time having a predetermined distance from one another. By specifying a specific temporal distance for the values of the oxidizing agent concentration to be compared with one another, the detection of the magnitude of the change of the oxidizing agent concentration is facilitated since, of course, the magnitude of the change will tend to be smaller within short periods of time than during long periods of time.

For the distance of the two points in time from one another, for example, a value can be specified which is larger than or equal to 50 ms and less than or equal to 10 s, in particular larger than or equal to 500 ms and less than or equal to 2 s. The fact that a distance to be taken as a basis for the determination of the change of the oxidizing agent concentration with time is specified at all, is more important than to which precise value the distance is set. Of course, the determination of the change of the oxidizing agent concentration can also be based on values detected at further points in time lying between the two points in time. For example, the dependence of the detected values of the oxidizing agent concentration on time can be modeled by a function (e.g. carrying out a linear regression).

It should also be noted that the inventive method can in particular also be carried out in a chamber arranged outside of an additive manufacturing apparatus.

Preferably, welding fume residues that have been filtered out of the protective gas by a filter element are oxidized.

Preferably, the protective gas that has been passed through the process chamber is supplied to a filter system and from the filter system is recirculated to the process chamber. The filter system contains at least one filter chamber through which the protective gas stream is passed. The side of the filter chamber at which the protective gas stream enters the filter chamber is also referred to below as the raw gas side. The side of the filter chamber at which the protective gas stream leaves the filter chamber again after passing through a filter element is also referred to below as the clean gas side. In a filter chamber there is at least one filter element that is suitable for filtering out particles located in the protective gas stream which then remain on the filter element as welding fume residues. In particular, a filter element can be cleaned by a gas pressure surge, i.e. welding fume residues deposited on the filter element as a result of the use of the filter element in the protective gas stream can be removed by means of a gas pressure surge.

Further preferably, the welding fume residues are exposed to the gas atmosphere containing the oxidizing agent together with the filter element.

The chamber in which welding fume residues are passivated can be in particular the filter chamber in which the filter element is located.

Preferably, in the passivation according to the invention, the oxidizing agent is supplied to the chamber without previous or accompanying supply of a passivating agent, e.g. lime, that does not act by means of oxidation.

If the method of oxidizing welding fume residues is carried out in a filter chamber with an installed filter element, this can take place before a cleaning process of the filter element. As a result, the risk of self-ignition of the cleaned welding fume residues is avoided since welding fume residues on the filter element that are removed by the cleaning process are passivated in advance in a controlled manner so that after cleaning they can be disposed of more safely. Likewise, however, the method of oxidizing welding fume residues in the filter chamber can also be carried out after a cleaning process of the filter element. In this case, deep-seated welding fume residues on the filter element, i.e. the “base contamination”, can be oxidized in a controlled manner. Since the filter element is more permeable as a result of the cleaning, i.e. has a lower resistance to the gas flow, also more oxidizing agent (oxygen) per unit time reaches the filter element.

Further preferably, the filter element can be cleaned by a gas pressure surge and welding fume residues that have been removed from the filter element by a cleaning process are exposed for the passivation time period to the gas atmosphere containing the oxidizing agent.

In this procedure, welding fume residues that have been removed from the filter element by a cleaning process, which are collected in a collecting container, can be oxidized in a controlled manner in this collecting container before they are removed from the collecting container, as a result of which oxygen is possibly added in an uncontrolled manner. For the controlled oxidation, the collecting container can be closed in a gas-tight manner with respect to the filter chamber and thus serve as a chamber for the controlled oxidation. However, it is also possible to carry out an oxidation in the collecting container while the latter is connected to the filter chamber by means of a gas-permeable connection. In particular, a section of the filter chamber can serve as a collecting container, preferably at the base thereof.

It should also be noted that it is also conceivable to limit the amount of the welding fume residues arising from cleaning processes, which are exposed to the gas atmosphere containing an oxidizing agent for the limited time period in the chamber, to a maximum value. For example, this can be implemented by ensuring that an oxidation cannot take place if cleaned-off welding fume residues from four cleaning processes, preferably three cleaning processes, more preferably two cleaning processes, are in the chamber. This increases safety since the amount of the initially pyrophoric material is limited.

Further preferably, the welding fume residues are supplied to a waste container and the waste container and/or a volume arranged between the filter element and the waste container serves as a chamber in which the welding fume residues are exposed to the gas atmosphere containing the oxidizing agent.

As a rule, cleaned-off welding fume residues are finally supplied to a waste container which is attached to the additive manufacturing apparatus and with which the welding fume residues can be disposed of or can be brought to recycling. A regular removal of the welding fume residues from the waste container, for example by suction, is also conceivable. Such a waste container too can serve as a chamber for carrying out the oxidation method according to the invention if at least one sensor for detecting the oxidizing agent concentration in the waste container is provided in the waste container and corresponding connections for supplying and discharging a gas containing an oxidizing agent and a control apparatus for controlling the passivation process according to the invention are provided.

Alternatively or additionally, an intermediate container serving specifically for a passivation by controlled oxidation can also be provided between the filter element and the waste container, which intermediate container then serves as a passivation chamber. In particular, the wall of such a passivation chamber can be adapted such that it can withstand a pressure difference of up to 8 bar, preferably up to 15 bar, in order to increase safety. Similarly to the case of the waste container, at least one sensor for detecting the oxidizing agent concentration in the passivation chamber is then provided and corresponding connections for supplying and discharging a gas containing an oxidizing agent and a control apparatus for controlling the passivation process according to the invention are provided.

Preferably, the volume arranged between the filter element and the waste container, which volume serves as a chamber in which the welding fume residues are exposed to the gas atmosphere containing the oxidizing agent, is a conveying screw, wherein preferably the oxidizing agent concentrations in the conveying screw, which are detected at two points in time having a predetermined distance from one another, are detected by two different sensors which detect the oxidizing agent concentrations at two positions in the conveying screw spaced apart from one another in the conveying direction.

In this embodiment of the invention, the oxidation of the welding fume residues can take place in the space between the threads of the conveying screw. Here, the oxidizing agent can be supplied to the space between the threads e.g. by means of a gas containing the oxidizing agent via an oxidizing agent inlet, so that an oxidation reaction can then take place during the transport of the welding fume residues in the conveying screw. As a result of the use of the conveying screw, the welding fume residues can also be compressed at the same time, so that the passivated welding fume residues can be stored in the collecting container in a space-saving manner.

In an alternative inventive method of oxidizing welding fume residues of an additive manufacturing apparatus adapted to process a metal-based building material,
wherein the additive manufacturing apparatus comprises a process chamber for manufacturing a three-dimensional object and
a circulation system having a gas circuit for a protective gas which is passed through the process chamber,
wherein the welding fume residues are exposed to a gas atmosphere containing an oxidizing agent for a passivation time period in a conveying screw,
wherein oxidizing agent concentrations and/or oxidizing agent partial pressures at positions in the conveying screw spaced apart from one another in the conveying direction are detected by at least two sensors.

If the welding fume residues in a conveying screw are exposed to the oxidizing agent, in other words are oxidized, this leads to the fact that welding fume residues at different positions in the conveying direction have been exposed to the oxidizing agent for different time periods. Close to the inlet of the conveying screw, not much time has passed since the welding fume residues entered, while the material “downstream” in the conveying direction has already spent a relatively long time in the conveying screw since it entered. It is thus possible to determine a different reaction behaviour of the welding fume residues during the oxidation, in particular a different oxidation state of the welding fume residues, by detecting oxidizing agent concentrations and/or oxidizing agent partial pressures at locations spaced apart from one another in the conveying direction.

If the welding fume residues in a conveying screw are exposed to the oxidizing agent, a difference between oxidizing agent concentrations and/or oxidizing agent partial pressures determined at two different positions in the conveying direction thus corresponds to a difference between oxidizing agent concentrations and/or oxidizing agent partial pressures determined at one and the same location at two different points in time having a predetermined distance from one another. In the alternative procedure, the sensor measurements performed at different points in time in accordance to the inventive approach described further above can thus be replaced by sensor measurements performed at different locations.

Apart from the fact that in the alternative approach the welding fume residues are passivated in a conveying screw and that the passivation time period is not necessarily ended depending on a difference between oxidizing agent concentrations in the chamber detected by at least one sensor at two or more points in time having a predetermined distance from one another, although this is also possible, all variants and modifications of the inventive approach described further above are possible in the same way in the alternative approach.

In particular, welding fume residues which have been filtered out of the protective gas by a filter element can thus be oxidized, wherein optionally the welding fume residues can be exposed to the gas atmosphere containing the oxidizing agent together with the filter element. Furthermore, the welding fume residues can be exposed to the gas atmosphere containing the oxidizing agent together with the filter element and can optionally be supplied to a waste container thereafter, in which case the conveying screw is arranged between the filter element and the waste container.

Preferably, in the alternative approach, a control device exists which is adapted to control a passivation time period in which the welding fume residues in the conveying screw are exposed to the gas atmosphere containing an oxidizing agent such that the passivation time period is ended depending on a difference between the oxidizing agent concentrations in the chamber detected by the at least two sensors at the same point in time or at two or more points in time having a predetermined distance from one another.

In a modification of the alternative inventive method, the amount of the welding fume residues oxidized in the conveying screw and/or the amount of the welding fume residues in the conveying screw is determined on the basis of the difference between the oxidizing agent concentrations determined by two or more sensors and/or on the basis of the difference between the oxidizing agent partial pressures determined by two or more sensors.

In this modification of the alternative procedure, at first the decrease of the oxidizing agent content in the conveying direction of the screw is determined by means of the two sensors. If it is assumed that the oxidation rate is so low that the reaction behaviour of the welding fume residues changes only insignificantly as a result of the oxidation, then the amount of welding fume residues reacting with the oxidizing agent between the two sensor locations can be determined on the basis of the amount of oxidizing agent consumed, the rotational speed of the screw cylinder and the screw geometry. If a constant material flow of the welding fume residues in the conveying screw is assumed, then the total amount of the welding fume residues in the conveying screw can be determined on the basis of the distance between the intake of the conveying screw for the welding fume residues and the outlet of the conveying screw.

It should be noted that a passivation according to the invention can basically be carried out in any volume between the filter element and the waste container which can be isolated in a gas-tight manner so that it can serve as a passivation chamber. In particular, welding fume residues which have deposited on the walls of a piping system between the filter element and the waste container can also be passivated thereby. In particular, the volume can also consist of the intermediate container and parts of the piping system for transporting the welding fume residues connected thereto. Furthermore, in a passivation according to the invention in the waste container, parts of the piping system for transporting the welding fume residues connected to the waste container can also be a component of the chamber serving for the controlled oxidation.

It should also be noted that it is also conceivable here to limit the amount of the welding fume residues arising from cleaning processes, which are exposed to the gas atmosphere containing an oxidizing agent for the limited time period in the chamber, to a maximum value. For example, this can be implemented by ensuring that an oxidation cannot take place if cleaned-off welding fume residues from four cleaning processes, preferably three cleaning processes, more preferably two cleaning processes, are in the chamber. This increases safety since the amount of the initially pyrophoric material is limited.

Preferably, welding fume residues which have deposited in the process chamber or in a gas pipe system connected to the process chamber are exposed to the gas atmosphere containing the oxidizing agent in the process chamber or in the gas pipe system connected to the process chamber.

Further preferably, the entire gas space serving for the protective gas circuit serves as a chamber in which the welding fume residues are exposed to the gas atmosphere containing an oxidizing agent for a passivation time period.

By this approach, welding fume residues which in the course of the additive manufacturing have deposited on the walls of the process chamber and of the gas pipe system existing for providing the protective gas atmosphere can be oxidized in a controlled way in the manner according to the invention. In this case, the process chamber and/or the gas pipe system adjoining it can serve as a passivation chamber if at least one sensor for detecting the oxidizing agent concentration is provided therein and corresponding inlets/outlets suitable for supplying and discharging a gas containing an oxidizing agent and a control apparatus for controlling the passivation process according to the invention are provided. In principle, the gas pipe system serving for providing the protective gas atmosphere can also be used for supplying and discharging the gas containing the oxidizing agent. Then, either the entire gas space serving for the protective gas circuit, in other words the entire circulation system, can serve as a passivation chamber, an oxidation then occurs everywhere at the same time, meaning, as the case may be, also in a filter chamber, or closure devices can be provided which isolate in a gas-tight manner the process chamber and adjoining parts of the gas pipe system from the rest of the system serving for providing the protective gas circuit. In the latter case, of course, a separate inlet and outlet for the gas containing the oxidizing agent must be provided.

It should also be emphasised that here the term “gas pipe system” is understood such that it comprises not only a piping system serving for the protective gas circuit, but can also comprise further devices through the protective gas flows, such as e.g. a cyclone separator for separating particles of the building material from the protective gas or a gas conveying device, e.g. a circulation fan.

Usually, the controlled oxidation just described is carried out when no reactive building material is present in the process chamber, i.e. in particular after completion of a manufacturing process after the manufactured object or the manufactured objects together with the building material have been removed from the process chamber or have been covered/separated in a gas-tight manner.

Preferably, the passivation time period is ended when the difference between the oxidizing agent concentrations detected at two points in time having a predetermined distance from one another falls below a predetermined threshold value.

Thus, in this approach, the passivation time period is ended in particular when the oxidizing agent concentration no longer changes much, which indicates that the oxidation reaction is no longer so strong, for example because surfaces of the particles of the welding fume residues which have not yet been oxidized are no longer so easily accessible to the oxidizing agent. If the passivation time period is ended in such a case, as a result the length of the passivation process can be limited. Since the time required for an oxidation of further quantities of the welding fume residues becomes longer and longer, an ineffective waiting can be avoided by ending the passivation time period and thus the entire passivation process can proceed more efficiently.

The predetermined threshold value can depend on the nature of the welding fume residues. A typical threshold value for strongly reacting welding fume residues would be a change of the oxidizing agent concentration of the gas atmosphere by 0.05% by volume per second. A typical threshold value for weakly reacting welding fume residues would be a change of the oxidizing agent concentration of the gas atmosphere by 0.05% by volume per hour. In particular, the ideal threshold value can also be determined by a limited number of preliminary tests.

In addition to the chemical composition thereof, the reactivity of the welding fume residues can also depend on the size of the specific surface thereof or on the granularity of the particles therein, on the oxidizing agent concentration in the gas atmosphere present in the chamber at the beginning of the passivation time period or on the temperature in the chamber, in particular on the temperature of the welding residues and the heat dissipation thereof to the outside.

Likewise preferably, the passivation time period is ended when values of the oxidizing agent concentration of the gas atmosphere registered by the sensor within a predetermined reference time period differ from one another by an amount which lies within a predetermined fluctuation interval.

In this approach, the passivation time period is likewise ended when the oxidizing agent concentration no longer changes much, as a result of which the length of the passivation process can be limited.

The predetermined fluctuation interval defines a value corridor for the oxidizing agent concentration and can depend on the nature of the welding fume residues. Preferably, the width of the fluctuation interval lies between 0.1% by volume and 1% by volume for strongly reacting welding fume residues and between 0.01% by volume and 0.1% by volume for weakly reacting welding fume residues. In particular, the ideal value for the width of the fluctuation interval can also be determined by a limited number of pretests.

Likewise preferably, the two points in time having the predetermined distance from one another, with respect to which a difference between the detected oxidizing agent concentrations is determined, lie within an initial time period at the beginning of the passivation time period and the passivation time period is ended when, after the end of the initial time period, a difference between oxidizing agent concentrations detected at two points in time having the predetermined distance from one another is smaller by a predetermined percentage than the difference determined within the initial time period.

In this approach, the percentage by which a rate of change of the oxidizing agent concentration determined at the beginning of the passivation time period has decreased in the course of the passivation time period is determined. The advantage of this approach is that the rate of change of the oxidizing agent concentration has to be determined only once. A percentage which is preferably larger than or equal to 10% and/or less than or equal to 100%, further preferably larger than or equal to 50% and/or less than or equal to 90% and particularly preferably larger than or equal to 60% and/or less than or equal to 80% can serve as a criterion for ending the passivation time period.

The initial time period is a time range which extends from the beginning of the passivation time period to an end time which, in the case of weakly reacting welding fume residues and/or low temperatures in the chamber, can even lie only at one hour after the beginning. In the case of strongly reacting welding fume residues and/or high temperatures in the chamber, a time period of 10 seconds is preferably selected as the length of the initial time period. Further preferably, the initial time period can be started only 2 seconds after the beginning of the passivation time period.

In order to determine when the temporal change has decreased by a specified percentage, the temporal change of the oxidizing agent concentration is determined continuously (preferably at regular intervals) during the passivation time period and compared with the value of the temporal change determined for the initial time period.

Likewise preferably, a time constant of an exponential decrease of the oxidizing agent concentration is determined on the basis of the difference between the oxidizing agent concentrations detected at two points in time having the predetermined distance from one another and from this the point in time of the end of the passivation time period is determined.

The decrease of the oxidizing agent concentration in the chamber depends exponentially on the time. This follows from the fact that the reaction rate is proportional to the existing oxidizing agent concentration (e.g. the existing oxygen partial pressure). Therefore, the change of the oxidizing agent concentration with time can be detected at any point in the passivation time period (preferably close to the beginning thereof) and the entire exponential curve can be extrapolated from the course of the curve. In particular, in order to determine the change of the oxidizing agent concentration with time, values of the oxidizing agent concentration can be detected at more than two points in time (at intermediate points in time). Preferably, the values for the oxidizing agent concentration detected at the different points in time can be plotted logarithmically, a straight line can be determined by means of linear regression, with which the logarithmic values thus plotted are approximated and the time constant of the exponential decrease can be calculated from the slope of the straight line. Having knowledge of the time constants, the entire exponential curve can be extrapolated. On the basis of this curve, it can then be determined, for example, when a predetermined threshold value for the change of the oxidizing agent concentration with time is undershot or at which point in time a temporal change of the oxidizing agent concentration determined in an initial time period will have decreased by a predetermined percentage. It should be noted that the initial concentration of the oxidizing agent is known, since it corresponds to the concentration of the oxidizing agent in the gas supplied for the oxidation or to the predetermined oxidizing agent concentration.

Preferably, the oxidizing agent supply into the chamber is switched off before the oxidizing agent concentration is detected with the sensor.

In this approach, a specific amount of oxidizing agent can be supplied to the filter chamber or a specific value of the oxidizing agent concentration in the chamber atmosphere can be set and then the oxidizing agent supply can be stopped, so that oxidation processes in the filter chamber then proceed without further supply of oxidizing agent.

The advantage of such an approach is that in such a case the change of the oxidizing agent concentration with time can be determined more precisely. The reason is that with a steady oxidizing agent supply, temporal changes of the oxidizing agent concentration can be detected locally, but the detected values are influenced by the flow ratio in the chamber. For reliable measurements, stable flow conditions are required, since otherwise turbulences can skew the value of the determined oxidizing agent concentration.

Preferably, the welding fume residues are exposed to the gas atmosphere containing the oxidizing agent in a temporarily gas-tight closed chamber.

If the chamber is closed in a gas-tight manner during the passivation time period, then the oxidizing agent concentration to be detected with the at least one sensor can be detected more precisely, since otherwise oxidizing agent can leave the chamber in an uncontrolled way, as a result of which the determined temporal change of the oxidizing agent concentration is skewed.

Preferably, at least one of the following steps is carried out after an end of the passivation time period:
the outputting of a signal indicating the openability of the chamber or indicating the possibility of the access of air to the chamber,
the automated or manual removal of the welding fume residues from the chamber.

On the one hand, the ease of operation and on the other hand the safety are increased by such a procedure. By outputting a signal, an operator is immediately and directly informed of the safety when the chamber is opened, so that passivated welding fume residues can be removed manually. Preferably, the removal of the welding fume residues is carried out automatically after the end of the passivation time period. In particular, this is appropriate when the passivated welding fume residues no longer adhere to walls, e.g. when welding fume residues are involved which have been obtained by a cleaning process on a filter element.

The output signal can be output, for example, by means of a light display or via a screen display of a control device controlling the process of the controlled oxidation.

An inventive apparatus for oxidizing welding fume residues of an additive manufacturing apparatus adapted to process a metal-based building material,
wherein the additive manufacturing apparatus comprises a process chamber for manufacturing a three-dimensional object and
a circulation system having a gas circuit, the circulation system being adapted to pass a protective gas through the process chamber, comprises:
a chamber adapted to oxidize the welding fume residues, comprising a closable inlet for supplying a gas containing an oxidizing agent in order to provide for a gas atmosphere containing an oxidizing agent in the chamber,
at least one sensor for detecting an oxidizing agent concentration in the chamber and
a control device adapted to control a passivation time period in which the welding fume residues in the chamber are exposed to the gas atmosphere containing an oxidizing agent such that the passivation time period is ended depending on a difference between oxidizing agent concentrations in the chamber detected by the at least one sensor at two points in time having a predetermined distance from one another.

Thereby, such an apparatus enables the above-mentioned inventive method of oxidizing welding fume residues to be carried out.

Preferably, in the inventive apparatus for oxidizing welding fume residues, the sensor comprises an oxygen sensor.

Preferably, oxygen is used as an oxidizing agent. The latter can exist in the form of O₂, O₃, or other compounds containing oxygen atoms, the oxygen content of which can act as an oxidizing agent. For example, paramagnetic sensors, resistance probes or Nernst probes can be used as sensors.

Further preferably, the circulation system is connected to a filter system having at least two filter chambers, wherein each of the filter chambers contains at least one filter element for filtering particles in the protective gas stream and at least one openable and closable valve for gas-tight isolation of the filter chamber from the circulation system and preferably at least one oxidizing agent sensor for detecting the oxidizing agent concentration of the gas atmosphere is arranged in the filter chamber,
wherein the control device is adapted to control openable and closable valves of the filter chambers such that in the filter chambers welding fume residues are filtered out of the protective gas and oxidized in the filter chambers alternately.

By means of such an embodiment of the filter system to which the additive manufacturing apparatus is connected, it becomes possible to carry out a cleaning on a filter element in a filter chamber while a manufacturing process in the process chamber is continued without interruption. Furthermore, an oxidation method according to the invention can be carried out in each of the filter chambers since at least one oxidizing agent sensor is arranged in the filter chambers. In other words, the filter chambers are chambers adapted to oxidize the welding fume residues.

Further preferably, the control device is adapted such that
in response to a request signal it isolates at least one of the filter chambers from the circulation system in order to supply the oxidizing agent to the at least one filter chamber and
the control device ensures that the protective gas stream flows through at least one filter chamber when a manufacturing process is taking place in the process chamber.

By means of such an embodiment, a controlled oxidation process in the filter chamber can be initiated in a targeted manner. The request signal can be generated manually by an operator or can be generated automatically if certain boundary conditions are fulfilled, for example when the pressure difference between the raw gas side and the clean gas side of the filter element exceeds a predetermined maximum permissible value. Since the control device is adapted to ensure that the protective gas supplied to the process chamber flows through at least one filter chamber, a manufacturing process in the process chamber does not have to be interrupted for the oxidation process in one of the filter chambers. This increases efficiency.

Further preferably, the control device is adapted such that before supplying oxidizing agent to one of the filter chambers isolated from the circulation system it induces a cleaning of the filter element in this filter chamber by means of a gas pressure surge.

In this case, deep-seated welding fume residues on the filter element, i.e. the “base contamination”, can be oxidized in a controlled manner. Since the filter element is more permeable as a result of the cleaning, i.e. has a lower resistance to the gas flow, more oxidizing agent (for example oxygen) per unit time reaches the filter element.

Preferably, protective gas from at least two additive manufacturing apparatuses is supplied to the filter system.

As a result, a filter system which can contain a plurality of filter chambers and filter elements can be used efficiently.

In an alternative inventive apparatus for oxidizing welding fume residues of an additive manufacturing apparatus adapted to process a metal-based building material, the additive manufacturing apparatus comprises a process chamber for manufacturing a three-dimensional object and a circulation system having a gas circuit, the circulation system being adapted to pass a protective gas through the process chamber. The apparatus further comprises a conveying screw adapted to oxidize the welding fume residues, comprising a closable inlet for supplying a gas containing an oxidizing agent in order to provide for a gas atmosphere containing an oxidizing agent in the conveying screw, and at least two sensors at the conveying screw for detecting oxidizing agent concentrations and/or oxidizing agent partial pressures at points in the conveying screw spaced apart from one another in the conveying direction.

It should be emphasized that all described modifications and possible uses of the inventive apparatus for oxidizing welding fume residues are equally applicable in connection with the alternative inventive apparatus.

Preferably, the alternative inventive apparatus comprises a control device adapted to control a passivation time period in which the welding fume residues in the conveying screw are exposed to the gas atmosphere containing an oxidizing agent such that the passivation time period is ended depending on a difference between the oxidizing agent concentrations in the conveying screw detected by the at least two sensors at the same point in time or at two points in time having a predetermined distance from one another.

Further features and advantages of the invention will become apparent from the description of exemplary embodiments with reference to the attached drawings.

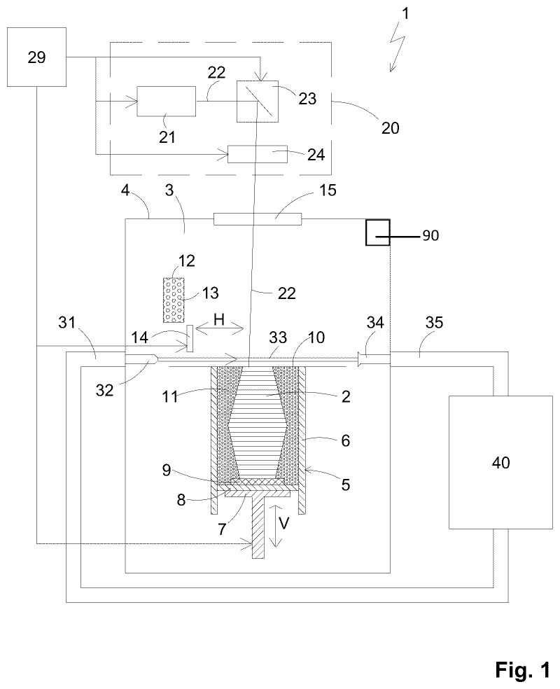

FIG. 1 shows a schematic, partially sectional view of an exemplary apparatus for additive manufacturing of a three-dimensional object in accordance with the invention.

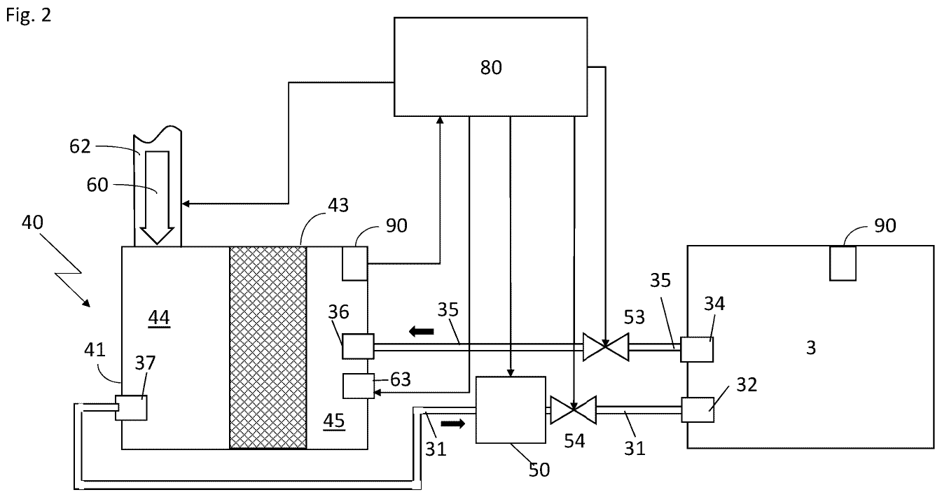

FIG. 2 shows a schematic representation of an embodiment of a (protective gas) circulation system.

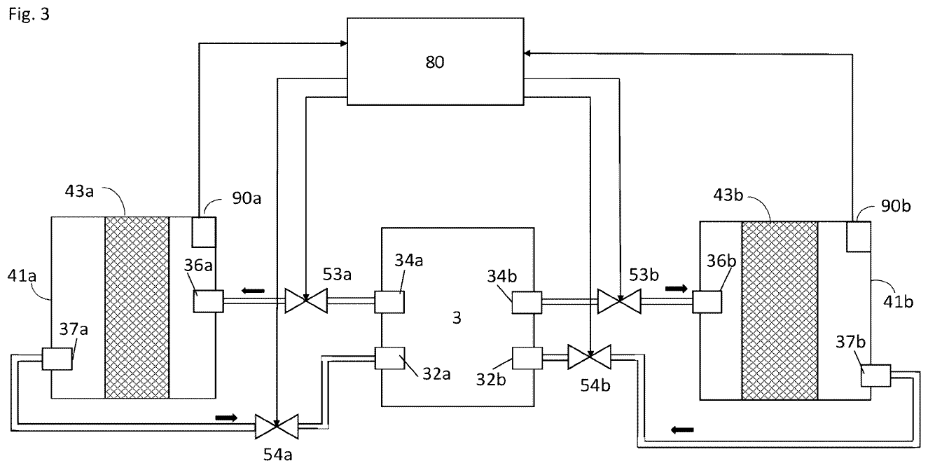

FIG. 3 shows a schematic representation of a further embodiment of a (protective gas) circulation system.

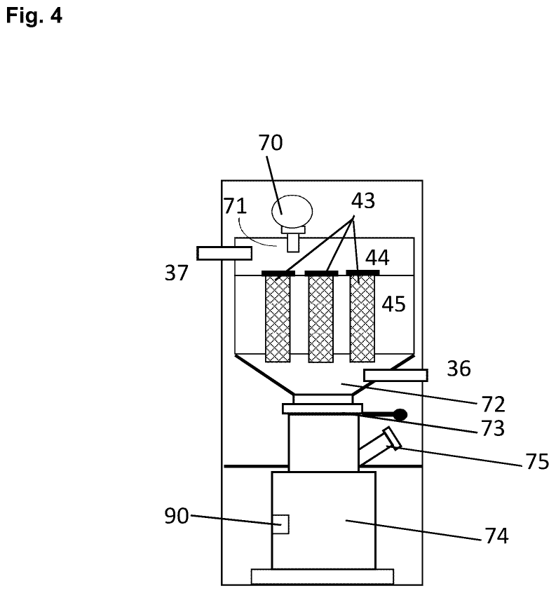

FIG. 4 shows a schematic representation of a setup for cleaning a filter element.

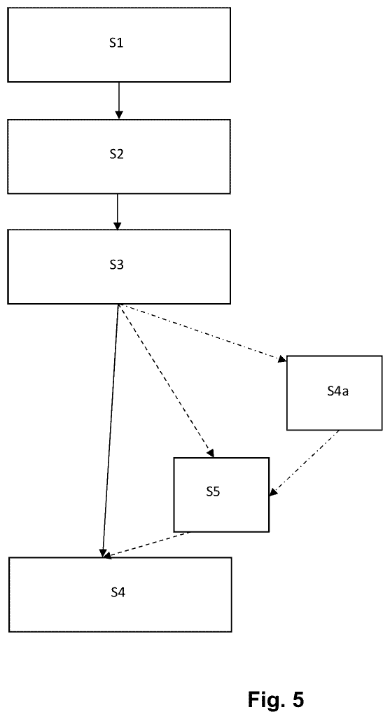

FIG. 5 shows a flow chart for explaining an oxidation process on a filter element.

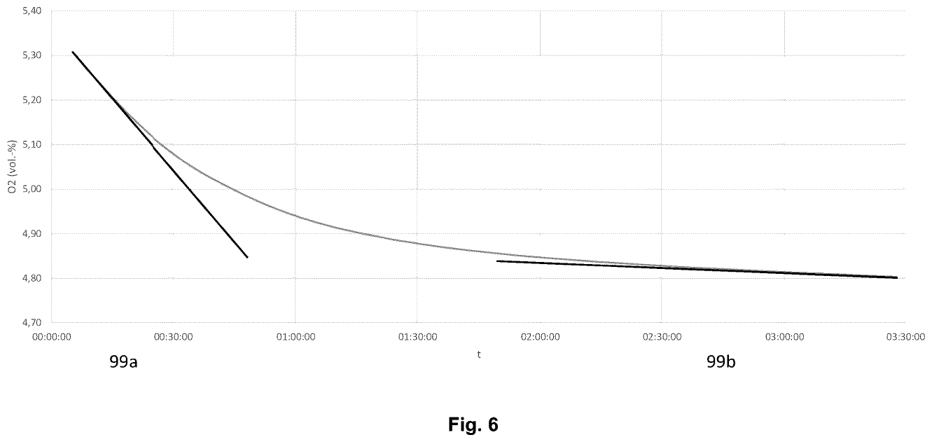

FIG. 6 shows a diagram for explaining a second procedure for determining the ending time of the time period within which an oxidation takes place in the chamber.

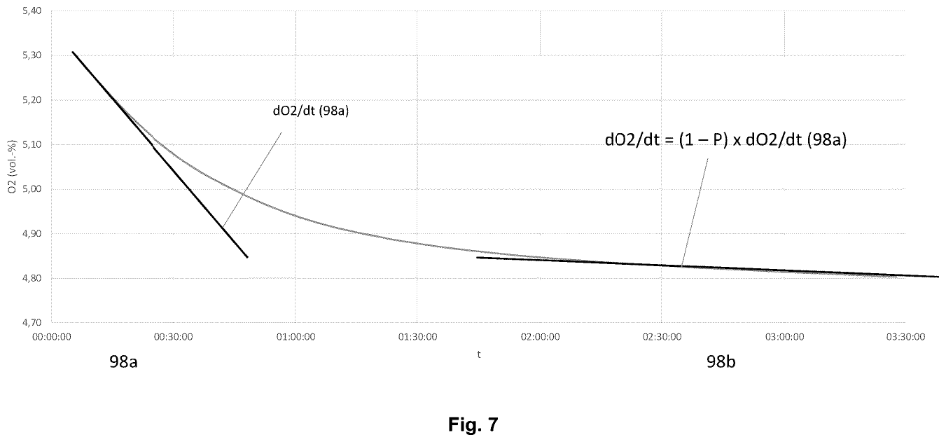

FIG. 7 shows a diagram for explaining a third procedure for determining the ending time of the time period within which an oxidation takes place in the chamber.

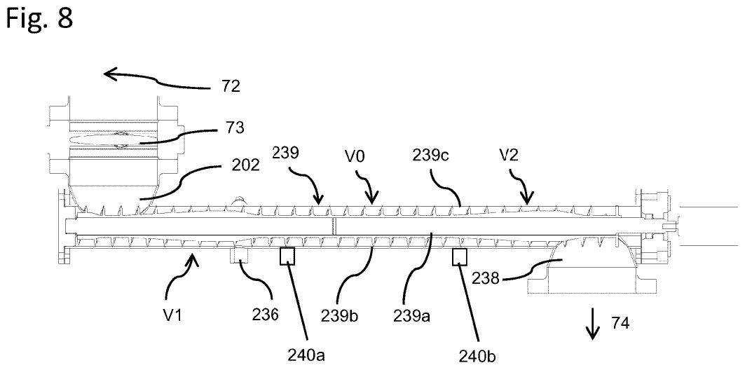

FIG. 8 shows an embodiment in which a screw conveyor is used as an oxidation chamber.

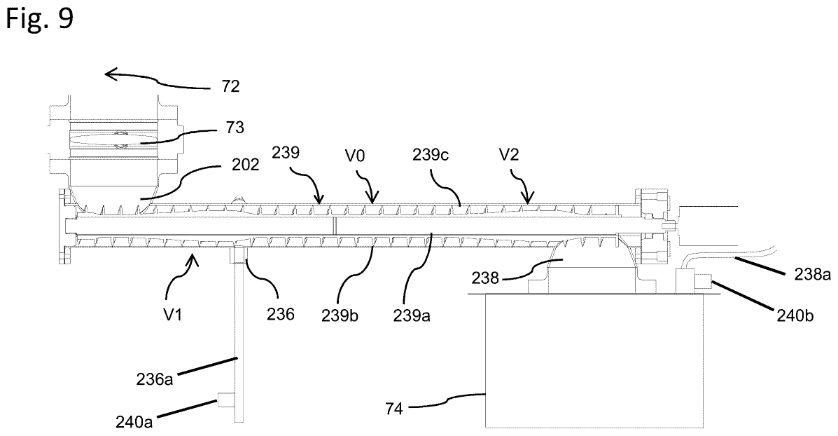

FIG. 9 shows the embodiment of FIG. 8 with an alternative arrangement of the oxidizing agent sensors.

In the following, with reference to FIG. 1, at first a basic structure of an additive manufacturing apparatus to which the present invention relates is described using the example of a laser sintering or laser melting apparatus. For constructing an object 2, the laser melting apparatus 1 shown in FIG. 1 contains a process chamber 3 having a chamber wall 4.

A container 5, which is open to the top and has a container wall 6, is arranged in the process chamber 3. A working plane 10 is defined by the upper opening of the container 5, wherein the region of the working plane 10 lying within the opening, which can be used for constructing the object 2, is referred to as a construction field.

A carrier 7, which is movable in a vertical direction V and to which a base plate 8 is attached, which closes off the container 5 at the bottom and thus forms the base thereof, is arranged in the container 5. The base plate 8 can be a plate formed separately from the carrier 7, which is fastened to the carrier 7, or it can be formed integrally with the carrier 7. Depending on the powder and process used, a construction platform 9 as a construction base on which the object 2 is constructed can additionally be attached to the base plate 8. However, the object 2 can also be constructed directly on the base plate 8, which then serves as a construction base. In FIG. 1, the object 2 to be formed in the container 5 on the construction platform 9 is shown below the working plane 10 in an intermediate state with a plurality of solidified layers, surrounded by building material 11 which has remained unsolidified.

The laser melting apparatus 1 further contains a storage container 12 for a metal-containing building material 13 in powder form or paste-like that can be solidified by electromagnetic radiation, and a coater 14, which is movable in a horizontal direction H for applying the building material 13 within the construction field. Preferably, the coater 14 extends transversely to its direction of movement over the entire region to be coated.

On its upper side, the wall 4 of the process chamber 3 contains a coupling window 15 for the radiation 22 serving to solidify the powder 13.

The laser melting apparatus 1 further contains an exposure device 20 with a laser 21, which generates a laser beam 22, which is deflected via a deflection device 23 and focused by a focusing device 24 via the coupling window 15 onto the working plane 10.

Furthermore, the laser melting apparatus 1 comprises a control unit 29, by which the individual components of the laser melting apparatus 1 are controlled in a coordinated manner for carrying out the construction process. The control unit can contain a CPU, the operation of which is controlled by a computer program (software). The computer program can be stored on a storage medium, from which it can be loaded into the apparatus, in particular into the control unit. In the present application, the term “control unit” includes any computer-based control unit which is capable of controlling or regulating the operation of an additive manufacturing apparatus, in particular of components thereof. Here, the connection between control unit and controlled components need not necessarily be cable-based, but can also be implemented by means of radiocommunication, WLAN, NFC, Bluetooth or the like, in that the control unit comprises corresponding receivers and transmitters.

In operation, in order to apply a layer of the building material, the carrier 7 is first lowered by an amount that corresponds to the desired layer thickness. Then, the coater 14 travels over the construction field and applies there a layer of building material 13 on the construction base or an existing layer of already selectively solidified building material. The application takes place at least over the entire cross section of the object 2 to be manufactured, preferably over the entire construction field, that is to say the region delimited by the container wall 6.

Then, the cross section of the object 2 to be manufactured is scanned with the laser beam 22, so that the building material 13 in powder form is solidified at the locations that correspond to the cross section of the object 2 to be manufactured. Here, the powder grains are partially or completely melted at these locations by means of the energy introduced by the radiation, so that after cooling they exist connected to one another as a solid. These steps are repeated until the object 2 is completed and can be removed from the process chamber 3.

Preferably, metal-containing building materials are used, for example iron- and/or titanium-containing building materials, but also copper-, magnesium-, aluminum-, tungsten-, cobalt-, chromium- and/or nickel-containing materials. The mentioned elements can be present on the one hand almost in pure form (making up more than 80 percent by weight of the building material) or as components of alloys.

In order to avoid impairments of the manufacturing process by welding fume arising during the melting of the building material, a protective gas stream is passed over the working plane 10. Therefore, for generating a laminar gas stream 33 above the working plane 10, the laser sintering apparatus 1 contains a gas supply channel 31, a gas inlet nozzle 32, a gas outlet nozzle 34 and a gas discharge channel 35. The gas supply and discharge too can be controlled by the control unit 29. Via the gas discharge channel 35, the gas exiting from the process chamber 3 is supplied to a filter system 40, which filters out the impurities from the protective gas, and then is recirculated to the process chamber 3 via the gas supply channel 31. As a result, a circulation system having a closed gas circuit is formed.

FIG. 2, which relates to an exemplary embodiment, shows a schematic representation of a (protective gas) circulation system. Here, the filter system 40 contains a filter chamber 41, in which a number of schematically represented filter elements 43 serve for filtering the gas stream (in the following, sometimes also referred to as raw gas) which contains the welding smoke and is supplied via the gas discharge channel 35 and the gas inlet 36. For example, fabric filters having 20 μm polyester fibers or PE sinter filters can be used as filter elements. The filtered gas (in the following, sometimes also referred to as clean gas) is recirculated via the gas outlet 37 and the gas supply channel 31 to the process chamber 3, where it enters the gas inlet 32 arranged in the chamber wall of the process chamber 3. Preferably, the gas inlet 36 is configured such that the supplied gas stream is not aimed directly onto a filter element. For example, the gas can be directed laterally into the filter chamber on a circular path. As a result, a cyclone effect is used and larger particles, e.g. components of the building material (e.g. metal powder) that are transported, do not reach the filter element at all.

To bring about a gas flow, a gas conveying device 50, e.g. a circulation fan, is arranged in the gas circuit, wherein the flow direction in the gas circuit is indicated by arrows. Not shown in the figure are a preferably present fine filter, which is arranged upstream of the gas conveying device 50, and an optional particle separator in the gas discharge channel 35.

Over time, the filtered-out welding fume residues are deposited on a fabric of the filter element 43. They are compressed by the pressure exerted by the protective gas stream and can agglomerate depending on the material and the temperature. Thus, over time, a filter coating is formed from a layer of compressed welding fume residues and/or welding fume residues adhering to each other, which is usually referred to as a “filter cake”. It obstructs the protective gas stream and leads to an ever increasing pressure drop at the filter, that is to say to an increase in the pressure difference between the raw gas side and the clean gas side of the filter element, that is to say between the region 45 (raw gas side) between the gas inlet 36 and the filter element 43 and the region 44 (clean gas side) between the filter element 43 and the gas outlet 37.

An increased pressure difference leads to higher heat losses of the gas conveying device 50, which causes the protective gas temperature to rise in an undesirable manner. Therefore, the filter element 43 has to be cleaned from time to time in order to remove the filter cake. Here, the approach is shown schematically with reference to FIG. 4. In the other figures, apparatus details associated with a cleaning operation have not been depicted for reasons of clarity.

In FIG. 4, a cleaning device 70 is arranged downstream of the filters 43 arranged in parallel to each other in the gas stream, that is to say such that it can be brought into connection with the region 44 between the number of filter elements 43 and the gas outlet 37. It can contain, for example, a pressure vessel with pressurized protective gas, from which individual gas pressure surges are extracted as required.

For cleaning filter elements 43, a gas pressure surge is generated by the cleaning device 70 and is introduced into the region 44 via the cleaning nozzle 71. This gas pressure surge has, for example, a peak pressure of 5 bar and penetrates a cleanable filter element against the regular filter direction in which the protective gas to be filtered flows through the filter element 43. As a result, the gas pressure surge acts on the filter cake from the outlet side of the filter element 43. Accordingly, the filter cake is detached from the filter element 43 in a planar manner, breaks up into clods and is pushed away from the filter element 43 by the gas pressure surge. The individual pieces of the filter cake fall downward, attracted by gravity, and reach a collecting funnel 72, in the lower portion of which a closure 73, for example an iris diaphragm or a pneumatically/electrically actuated valve disk, is located, with which the collecting funnel 72 can be closed off downward in a gas-tight manner. A collecting container 74 (also referred to as a waste container) is located therebelow. Furthermore, a protective gas connection (not shown in the figure) can optionally be provided for introducing a protective gas, which is preferably identical to the protective gas used in the process chamber, into the collecting container 74. Further apparatus details known to the person skilled in the art are not depicted in schematic FIG. 4 for reasons of better clarity, for example a vent used for inerting the filter chamber or a filling level sensor in the collecting container 74.

The cleaning of a filter element 43 can be carried out at predetermined time intervals which are set in dependence of the manufacturing process taking place in the additive manufacturing apparatus, for example of the number of lasers and/or the operating times of the lasers which are used at the same time for an irradiation of the building material. However, the cleaning can also be carried out in dependence on contamination, for example by measuring the pressure difference between both sides of the filter element, that is to say between the region 44 and the region 45, which pressure difference increases as a result of the contamination. It is also possible to use differently strong pressure surges for the cleaning of the filter elements, e.g. weaker pressure surges for lower contaminations and stronger pressure surges for larger contaminations.

As a result of the cleaning processes, welding fume residues accumulate in the collecting container 74, so that the latter has to be emptied from time to time. This can be carried out, for example, by closing the closure 73 and hermetically closing the collecting container 74 with a gas-tight cover and removing the collecting container 74 from the filter system 40. Then, an empty collecting container 74 is inserted again into the filter system.

Optionally, before the collecting container is removed, a dry, free-flowing medium, such as e.g. quartz sand, as a passivation agent can be filled into the collecting container 74 via the passivation connection 75 in such a way that it forms a closed cover layer and shields explosive or reactive components of the filter waste against the access of oxygen. The passivation agent is a passivation material that differs from the protective gas (to be filtered or filtered), i.e. it can comprise in particular a liquid and/or solid material, preferably a material that is difficult to oxidize. Furthermore, a protective gas can optionally be introduced into the collecting container 74 via the protective gas connection (preferably before the filling of the above-mentioned passivation agent). Introducing the protective gas into the collecting container 74 before filling in the passivation agent has the advantage that the risk of ignition of the filter waste is further reduced since the filling in of the passivation material also causes a certain supply of kinetic energy into the collecting container 74.

The addition of passivation agent leads to the collecting container 74 being filled more quickly and therefore having to be changed more frequently. In order to be able to reduce the added amount of passivation agent or even to be able to dispense with it altogether, in the present embodiment a passivation of the welding fume residues filtered out by the filter element 43 is carried out already at the filter element itself. For this purpose, the filter chamber 41 shown in FIG. 2 has an oxidizing agent supply 62 via which an oxidizing agent 60 can be supplied to the filter chamber 41. Preferably, the oxidizing agent supply 62 is arranged such that the oxidizing agent, in particular oxygen, is supplied as a component of a gas mixture to the region 44 so that it has access to the filter element 43 from the clean gas side in order to be able to oxidize welding fume residues at the filter element. Of course, however, the gas containing the oxidizing agent can alternatively also be supplied to the region 45 on the raw gas side or (referring to FIG. 4) to the collecting container 74 if the closure 73 is open. In particular, the oxidation reaction can be initiated by supplying energy. For example, a radiant heating which heats the filter element can be used as energy supply means.

Alternatively, the gas mixture containing the oxidizing agent can be supplied in a heated condition or else a resistance heating, for example in the form of a heating braid surrounding the filter element 43 or the filter chamber 41, can be attached to the filter element 43 or to the filter chamber 41.

The process of an oxidation process at the filter element 43 is explained below with reference to the flow chart of FIG. 5. The process is controlled by a control device 80 shown in FIG. 2, which may but need not be a component of the control unit 29.

In an optional step S1, at first a cleaning process can be carried out at the filter element 43. During the cleaning process, preferably an inert gas atmosphere should exist in the filter chamber 41. This can also be the protective gas atmosphere in the process chamber 3, so that no separation of the two atmospheres is necessary per se. Nevertheless, during the cleaning process the filter chamber 41 is preferably isolated in a gas-tight way from the process chamber 3 in order to prevent a reaction of the gas pressure surge on the process chamber. This can be done, for example, by closing the shut-off valves 53 and 54 in FIG. 2 by means of the control device 80. It should be noted here that the representation in FIG. 2 is schematic and the shut-off valves 53 and 54 can also be arranged close to the filter chamber 41, even if the representation suggests otherwise.

In step S2, the control device 80 induces the access of the oxidizing agent 60, generally in the form of an oxygen-containing gas, e.g. an Ar—O₂ mixture (hereinafter also referred to as reaction gas), via the controllable oxidizing agent supply 62 in such a way that after a predefined time period has elapsed after the end of a gas pressure surge used for the cleaning, the gas atmosphere in the filter chamber has a predefined oxygen content (e.g. 5% by volume of oxygen, but it is also possible to work with other oxygen contents which are greater than or equal to 1% by volume and/or less than or equal to 20% by volume). In particular, a gas atmosphere in the chamber can be enriched with oxygen. In the present example, the oxygen content is increased linearly from 0.1% by volume to 5% by volume within 20 minutes. Here, a sensor 90 arranged in the filter chamber 41 serves to determine the oxygen content in the gas. Although only one sensor 90 is shown, also a plurality of sensors can be present. The sensors can detect, for example, the oxygen concentration, the oxygen partial pressure or else the total pressure (from which the oxygen concentration can be inferred when having knowledge of the supplied gas) in the filter chamber. For example, paramagnetic sensors or lambda probes/Nernst probes can be used. It should be noted that the sensor can also be arranged downstream of the reaction gas outlet 63 instead of being arranged in the region 45. The use of a plurality of sensors 90, for example one in the region 45 on the side of the filter element 43 facing away from the oxidizing agent supply 62 and one in the region 44 on the side of the filter element 43 facing the oxidizing agent supply 62, is also conceivable.

The amount of the supplied oxidizing agent can be controlled such that the oxygen content in the filter chamber increases continuously over time and the predefined oxygen content is reached at the end of the predefined time period. Here, it is preferably ensured that the oxygen content (the oxygen concentration) in the filter chamber does not increase too abruptly. By limiting the amount per unit time of the supplied oxidizing agent, sufficient time is available for a uniform distribution of the oxidizing agent until the predefined oxygen content is reached.

If the shut-off valves 53 and 54 have not already been closed for carrying out the cleaning, this should be done by means of the control device 80 before the supply of the oxidizing agent, since as a rule the presence of an oxidizing agent (oxygen) in the process chamber is undesirable.

As soon as the predefined oxygen content has been reached, which can be monitored by the sensor 90 or the sensors 90, the control device 80 closes the oxidizing agent supply 62. The welding fume residues in the filter chamber 41 can then react with the oxygen present in the filter chamber.

The progress of the oxidation reaction, which is intended to lead to a passivation of the welding fume residues, is in this case dependent on a plurality of parameters. On the one hand, the temperature and the oxygen content of the gas in the chamber have an influence. In addition, however, the amount of the material to be oxidized, its type (for example Ti-containing, Al-containing, Fe-containing) and its arrangement also play a role. The latter can be attributed to the fact that already existing oxide (these can be superficial oxide layers on the particles or else sufficiently oxidized particles, which shield the underlying particles with regard to the access of oxygen) obstructs a large-scale oxidation of the material.

Of course, a sufficient passivation will be achieved in particular when the oxidation reaction is allowed to proceed over a sufficiently long time period. However, this will lead to the situation that the filter chamber with the filter element are not operational over a long time period. In particular, when a manufacturing process in the process chamber has to be stopped or else the additive manufacturing apparatus is again operational only after the passivation of the welding fume residues, this will lead to a low efficiency in the operation of the additive manufacturing apparatus. Therefore, in the present approach, the length of the oxidation reaction is monitored and actively controlled.

For this, measurement values of the sensor 90 are output continuously (preferably at predetermined time intervals) to the control device 80 which determines therefrom the decrease of the oxygen concentration in the chamber over time. For example, in each case two values having a predetermined temporal distance (e.g. 1 second) from one each other can be compared with one another, However, a temporal change can also be determined taking into account more than two measurement values (e.g. by linear regression).

In a first approach, a decay of the oxidation reaction can be detected by the fact that the determined temporal change, i.e. the difference between two measurement values which were detected at a predetermined temporal distance from one another, falls below a predetermined threshold value, which indicates that the oxidation reaction comes to a halt. For titanium-containing building material in the additive manufacturing process (e.g. Ti64 powder) which reacts strongly with oxidizing agents, a threshold value which is greater than or equal to 0.05% by volume per second and less than or equal to 0.1% by volume per second can be considered to be realistic. For iron-containing building material which reacts weakly with oxidizing agents, a threshold value which is greater than or equal to 0.05% by volume per hour and less than or equal to 0.1% by volume per hour can be considered to be realistic. The last-mentioned range for the threshold value is of course also applicable in the case of titanium, but does not have to be set so low in the case of titanium-containing building material. In other words, in the case of titanium-containing building material, the passivation time period can be ended more rapidly.

In the case of other building materials which react moderately strongly with oxidizing agents (for example: AlSi10Mg), the threshold value to be chosen will lie between those for strongly and weakly reacting materials, for example in a range between 0.05% by volume per minute and 0.1% by volume per minute. The ideal threshold value can be determined on the basis of a limited number of pretests with welding fume samples from a manufacturing process with the building material to be used.

Alternatively, the fluctuation range of the measurement values returned by the sensor 90 can be used as a criterion for a decay of the oxidation reaction. As soon as it is discovered that the measurement values registered by the sensor within a predetermined reference time period (for example 30 minutes in the case of weakly reacting building materials such as, for example, Fe-containing building materials or else 10 seconds in the case of strongly reacting building materials such as, for example, Ti-containing building materials) show only a limited fluctuation, meaning they lie within a predetermined fluctuation interval, the control device 80 determines that the oxidation reaction has decayed.

After a decay of the oxidation reaction has been detected by the control device 80, an inert gas, the composition of which is preferably identical to the composition of the protective gas used in the process chamber, is supplied to the filter chamber 41 by means of the control device 80. This is step S3 in FIG. 5. Here, the inert gas can be supplied via the oxidizing agent supply 62 and can leave the filter chamber 43 again via the reaction gas outlet 63. Alternatively, the inert gas can also be supplied to the filter chamber via a protective gas connection (not shown in FIG. 4) which is provided for introducing a protective gas into the collecting container 74.

In step S4, after the oxygen content in the filter chamber 43, in particular in the region 44, is no longer above that in the process chamber 3, the shut-off valves 53 and 54 are opened again by the control device 80, so that the filter element 43 is again available for filtering the protective gas.

After a number of cleaning processes, the filter element 43 has to be exchanged or replaced since, with increasing operating time, contaminations which cannot be cleaned by the gas pressure surge accumulate on the filter element 43 or the filter cake can no longer be sufficiently detached from the filter element by the gas pressure surge. The time for exchanging a filter element that can be cleaned is inter alia dependent on the process parameters used for the building process, such as e.g. exposure strategies, laser parameters, etc., and the building material used. For example during a production process in the process chamber, the control device 80 can determine at regular time intervals a pressure difference between the raw gas side and the clean gas side of the filter element 43, meaning between the region 45 between the gas inlet 36 and the filter element 43 and the region 44 between the filter element 43 and the gas outlet 37, and can output to an operator a filter exchange signal indicating a filter exchange requirement, in case a threshold value is exceeded. Alternatively, the pressure difference determined after the just described oxidation method was carried out at the filter element 43 can be used as a basis for the decision that the filter element has to be exchanged. In any case, it is appropriate to exchange a filter element when the just described oxidation method was previously carried out at the filter element. Optionally, however, the filter element can also be cleaned by means of one or more pressure surges after the oxidation process before it is removed. The replacement process of the filter element, i.e. the replacement thereof by a replacement filter element, in particular a new filter element, corresponds to step S5 in FIG. 5.

In the present method, a casing of the filter element is not required when it is removed. In particular, the filter element 43 can be removed while the filter chamber 41 is left in the filter system 40. As a result of the previously carried out oxidation method, the risk of self-ignition of the filter element as due to the access of ambient air when the filter chamber is opened is greatly reduced or no longer present. In the prior art, this is not possible. There, a filter element casing must be provided which protects the filter element during the removal against the access of oxygen from the ambient atmosphere (air), which can be dispensed with in the just described approach.

If it is nevertheless desired to check whether self-ignition can occur during the removal of the filter element 43 and the access of atmospheric oxygen, step S4a can optionally be inserted between steps S4 and S5.

In step S4a, the reactivity of the impurities on the filter element 43 with oxidizing agent (e.g. oxygen) is checked. For this purpose, before a filter change, an oxygen-containing gas is supplied to the filter chamber 41, the supply of the oxygen-containing gas is stopped and, in the gas-tight closed filter chamber, the change of the oxygen content in the gas atmosphere over time is determined by means of the sensor or sensors 90 in the same way as has already been described further above. If the determined change over time falls below a predetermined threshold value or measurement values registered by the sensor within a predetermined reference time period show only a limited fluctuation, i.e. lie within a predetermined fluctuation interval, a signal is output by the control device 80 which indicates to an operator that the filter chamber 41 can be opened safely for a filter change.

The filter change step S5 can then be carried out by an operator. In order to do so, the operator should preferably ensure before the opening of the filter chamber 41 that the closure 73 is closed in a gas-tight manner so that no oxygen from the ambient air can reach the collecting container 74 and can cause uncontrolled oxidation reactions there when the filter chamber 41 is opened. Then, after the insertion of an exchange filter, step S4 can take place and a manufacturing process in the process chamber 3 can be continued or restarted.

During the filter cleanings, but also during the oxidation processes at the filter element, a manufacturing process in the process chamber is usually interrupted. In particular, this is the case when the filter element is changed, unless a continuation of the manufacturing process without cleaning the protective gas is tolerated. This problem can be avoided when a plurality of filter chambers is present, which is explained below with reference to FIG. 3.

FIG. 3 shows the two filter chambers 41a and 41b, which can be connected to the process chamber 3 via the shut-off valves 53a, 54a or 53b, 54b. In each of the two filter chambers 41a and 41b, an oxidation method described further above can be carried out at the filter element. However, as a result of the plurality of filter chambers present, a slightly different method sequence results. The differences of the method sequence from the one in FIG. 5 are explained below.

At first, it is assumed here by way of example that the filter chamber 41a is connected to the process chamber 3, while an additive manufacturing process is taking place in the latter. This means that the shut-off valves 53a and 54a are open and a gas stream, which has left the process chamber 3 at the gas outlet nozzle 34a, is supplied to the filter chamber 41a via the gas inlet 36a. The filtered gas is recirculated via the gas outlet 37a to the process chamber, where it enters the gas inlet 32a arranged in the chamber wall 4. The flow direction in this gas circuit is again indicated by arrows. A gas conveying device 50 arranged in the gas circuit to bring about a gas flow is not shown in FIG. 3 for reasons of clarity. While the gas to be filtered is supplied from the process chamber 3 to the filter chamber 41a, the shut-off valves 53b and 54b are closed.

In step S1, at first a cleaning process is carried out at the filter element 43a. During the cleaning process, preferably an inert gas atmosphere should exist in the filter chamber 41a. This can be the protective gas atmosphere present in the process chamber 3. Therefore, for carrying out the cleaning process, at first the shut-off valves 53a and 54a are closed by the control device 80 in order to isolate the filter chamber 41 in a gas-tight way from the process chamber 3 during the cleaning process and to prevent a reaction of the gas pressure surge on the process chamber. At the same time, the control device 80 opens the shut-off valves 53b and 54b in order to supply the gas stream leaving the process chamber 3 at the gas outlet 34b to the filter chamber 41b via the gas inlet 36b. As a result, during the cleaning process of the filter element 43a, a manufacturing process in the process chamber 3 can be continued without interruption in that the gas filtered by the filter element 43b is supplied via the gas outlet 37b to the process chamber, which it enters at the gas inlet 32b arranged in the chamber wall 4.

The further steps up to and including step S3 can now proceed in the same way as described above in connection with FIG. 5.

In step S4, when the oxygen content in the filter chamber 43a is no longer above the one in the process chamber 3, the shut-off valves 53a and 54a are opened again by the control device 80, while at the same time the shut-off valves 53b and 54b are closed by the control device 80, so that the process gas from the process chamber 3 is now filtered again by the filter element 43a.

If the filter element 43a has to be exchanged or replaced, as has been described above in connection with FIG. 5 on the basis of steps S4a and S5, during the entire period of time required for this a manufacturing process in the process chamber 3 can be continued without interruption in that during this period of time the process gas is filtered by the filter element 43b.

It should be emphasized that also more than two filter chambers can be present, of which in each case at least one is connected to the process chamber when a manufacturing process takes place in the process chamber. Further, each filter chamber does not necessarily have to be assigned its own gas outlet and inlet at the process chamber. It is also conceivable, using a branching, to connect in each case one of a plurality of filter chambers to a single gas inlet or gas outlet existing in the wall of the process chamber.

While a first approach was described above in which the fact that the determined change over time of the oxygen concentration falls below a predetermined threshold value or the fact that measurement values registered by the sensor within a predetermined reference time period show only a limited fluctuation was used as a criterion for a decay of the oxidation reaction, an alternative second approach is described below.

It can be assumed in good approximation that, as a result of the oxidation reaction, the oxygen concentration in the chamber decreases exponentially with time:

Mox.(t)=M0×exp(−t/τ),

wherein Mox denotes the oxygen concentration at the time t, M0 denotes the oxygen concentration at the starting point in time and T is a time constant of the exponential decrease.

FIG. 6 shows a schematic diagram in which on the abscissa the time is represented in the format hours: minutes: seconds and the ordinate denotes the oxygen content in the chamber (in % by volume). First of all, the described exponential decrease can be seen. In accordance with the second approach, during any time period after reaching the predefined oxygen content for the controlled oxidation (after the end of the oxygen supply), two determined values for the oxygen concentration having a predetermined temporal distance from one another are compared with one another or else the temporal change of the oxygen concentration is determined taking into account more than two measurement values. In the example of FIG. 6, this time period has reference sign 99a. The time constant T of the exponential decrease can be calculated from the determined temporal change (one could also determine the temporal change on the basis of a logarithmic plotting of the oxygen content in the chamber against time, which in particular makes it possible to carry out a linear regression). From the time constant T one can then determine at which point in time a temporal change of the oxygen concentration falls below a predetermined threshold value. Possible threshold values have already been mentioned with respect to the first approach. At this point in time (in the schematic example of FIG. 6, this point in time lies within the time range 99b), step S3 is carried out, as described above, wherein an inert gas is supplied to the filter chamber.

An alternative third approach for ending the passivation time period in dependence on the detected oxidizing agent concentration in the chamber is described in the following with reference to FIG. 7. The illustrative representation in FIG. 7 is almost identical to the one in FIG. 6, only the time ranges 99a and 99b have been replaced by the time ranges 98a and 98b.

In this third approach, the percentage P by which a rate of change of the oxidizing agent concentration determined at the beginning of the passivation time period, i.e. in an initial time period, has decreased in the course of the passivation time period is determined. In order to do so, at first a change of the oxidizing agent concentration or of an oxygen content in the oxygen-containing gas supplied to the chamber for the oxidation is determined within an initial time period 98a by determining the difference between the oxidizing agent concentrations detected by at least one sensor at two points in time having a predetermined distance from one another. A time range at the beginning of the oxidation reaction is chosen as initial time period. Since the reaction proceeds at a different pace depending on the building material, on the temperature and on other parameters, the choice of the initial time period in which the change of the oxidizing agent concentration is determined is adapted to the oxidation behaviour. For strongly reacting materials such as titanium, the measurement will be carried out within 10 seconds after the beginning of the passivation time period, preferably 5 seconds; in the case of weakly reacting materials such as iron, it is possible to allow more time, even if it is not detrimental to carry out the measurement within 10 seconds after the beginning of the passivation time period also in these cases.

In order to determine when the rate of change has decreased by a specified percentage, after the determination of the rate of change in the initial time period, the temporal change of the oxidizing agent concentration is determined continuously during the further course of the passivation time period (for example every 10 seconds for reactive welding smoke residues or every 10 minutes for not so reactive welding smoke residues) and compared with the value of the temporal change (dO2/dt(98a) determined for the initial time period 98a.

As soon as it is determined that the rate of change has decreased by the percentage value P, in FIG. 7 by way of example this is the case in the time range 98b, the passivation time period is ended. Die Änderungsrate im Zeitbereich 98b liegt dann bei dO2/dt=(1−P)×dO2/dt (98a).

The advantage of this approach is that a rate of change of the oxidizing agent concentration has to be determined only once. A percentage which is preferably larger than or equal to 10% and/or less than or equal to 100%, further preferably larger than or equal to 50% and/or less than or equal to 90% and particularly preferably larger than or equal to 60% and/or less than or equal to 80% is specified as a criterion for ending the passivation time period.

Even if the sensor-assisted determination of the time period for the passivation of welding fume residues by means of oxidation has been described so far with reference to a filter chamber 41, a passivation of welding fume residues by means of oxidation can also be carried out in other closed spaces in an analogous manner.

For example, a passivating oxidation can be carried out in the above-mentioned collecting container 74 depicted in FIG. 4 by using the latter as a chamber in which a number of sensors for determining an oxygen concentration are arranged and an oxidation is carried out in the same way as described above in connection with a filter chamber 41 (in particular steps S2 to S4 in FIG. 5). Such an optionally present sensor 90, which can be used for the optional passivating oxidation in the collecting container, is shown schematically in FIG. 4.

In the same way, it is also possible to provide a separate oxidation space (e.g. in the form of an oxidation chamber) between the closure 73 and the collecting container 74 in FIG. 4. The described sensor-controlled oxidation could then be carried out in such an oxidation space serving as a chamber in the same way as in the case of the oxidation in the collecting container 74. It should be noted that an oxidation can of course also be carried out simultaneously in the collecting container 74 and the separate oxidation space. In addition, in all the embodiments described so far, it is also possible to include pipes or gas spaces adjoining the respective chamber serving for the oxidation in the chamber serving for the oxidation by means of closure devices to be actuated accordingly.

In a special embodiment, a screw conveyor is used as an oxidation chamber. This is explained in more detail with reference to FIG. 8. The screw conveyor 239 in FIG. 8 has a cylindrical screw core 239a, to which a screw helix 239b is attached, wherein both are accommodated in a screw pipe 239c that is to be regarded as a wall of a reaction chamber for the oxidation. The diameter of the screw core 239a typically lies between 20 and 50 mm, the outer diameter (in the radial direction) of the screw helix 239b typically lies between 30 and 80 mm, the flight depth (thread depth) typically lies between 3 and 15 mm and the flight pitch angle (thread pitch angle) typically lies between 5 and 30 degrees. The flight pitch typically lies at a value between 80% and 100% of the outer diameter of the screw helix. The length of the screw typically has a value which is greater than or equal to 25 cm and less than or equal to 100 cm.

Though the radial dimensions of the screw can be constant along the path from the intake region 202 to the outlet 238 close to the collecting container 74, the screw geometry along the path can also be varied in order to create different zones in which either predominantly compression takes place or predominantly oxidation takes place.

The screw 239 shown in FIG. 8 comprises in particular two compression zones V1 and V2 and an oxidation zone V0 arranged between them. As is apparent from FIG. 8, a compression/compaction of the material is ensured in compression zones V1 and V2 by a flight depth which is reduced in comparison to the oxidation zone. As can be seen, a variation of the flight depth can be brought about by means of a change of the core diameter. Alternatively or additionally, the flight pitch could also be changed, but this is not shown in the figure.

It is also conceivable that, in contrast to FIG. 8, only one compression zone or more than two compression zones are present and/or more than one oxidation zone is present.

In FIG. 8, the first compression zone V1 is arranged close to the intake region 202 of the screw 239, preferably directly adjoining the intake region 202. Such an arrangement is advantageous since a welding fume residue that has been compacted in the screw is a barrier for the oxidizing agent and prevents or at least significantly reduces a back-flow of the oxidizing agent from the screw conveyor to the collecting funnel 71 and into the filter system 40. Furthermore, the second compression zone V2 is arranged close to the outlet 238. As a result, compacted oxidized welding fume residue, which takes up less volume in the collecting container 74, is fed to the collecting container 74, as a result of which the service life of the collecting container 74 is extended.

As shown in FIG. 8, the inlet 236 via which an oxidizing agent is supplied should be arranged in the area of the oxidation zone, preferably at the beginning thereof (when viewed in the conveying direction). In the case of a plurality of oxidation zones, an inlet 236 assigned thereto would preferably be provided for each of these oxidation zones. However, this is not intended to exclude the oxidizing agent being fed to an oxidation zone via a plurality of inlets; this is also possible.

By providing a plurality of oxidation zones, oxidation can be carried out in several stages. For example, the material is initially pre-oxidized in the first oxidation zone and further oxidized after having been transported to the second oxidation zone. For example, a larger amount of oxidizing agent (e.g. oxygen) can be supplied to the second oxidation zone for this purpose. In particular, the first oxidation zone can also merge into the second oxidation zone, wherein an inlet for an oxygen-containing gas or an oxygen-containing gas mixture is then arranged at each oxidation zone.

It is advantageous to arrange the oxidizing agent inlet 236 at the (in the vertical direction) lower end of the screw 239, as shown in FIG. 8. Such an arrangement ensures that a gas supplied via the inlet 236 produces a slight turbulence of the welding fume residues which tend to collect (due to gravity) in the lower region of the screw. This promotes an oxidation of the welding fume residues. Alternatively or additionally, an inlet 236 for a gas containing the oxidizing agent can be arranged above the screw. Such an arrangement has the advantage that the inlet 236 arranged above cannot become clogged so quickly by welding fume residues which collect primarily in the lower part of the screw due to gravity.

If a plurality of inlets 236 surrounds the screw in the circumferential direction (for example three inlets spaced apart from one another by) 120°, the oxidizing agent can be supplied uniformly from all sides and thus a homogeneous oxidation can be achieved.

The supplied gas should preferably also contain an inert gas in addition to oxygen, for example a mixture of oxygen and nitrogen or a mixture of an inert gas (e.g. argon, nitrogen) and air is possible. The total oxygen content in the gas typically lies between and 15% by volume, preferably between 8 and 12% by volume. Depending on the application, the total oxygen content during the course of the oxidation process can also lie in the range between 0 and 21% by volume. In particular, the total oxygen content is chosen depending on the oxidation reaction proceeding in the reaction chamber, i.e. in particular depending on the temperature in the reaction chamber. The oxygen can be present in the form of O₂, O₃, or other compounds containing oxygen atoms, the oxygen content of which can act as an oxidizing agent. Instead of an oxygen-containing gas, also a different oxidizing gas, which can also contain an oxidizing agent other than oxygen, or e.g. an oxidizing liquid, which is sprayed e.g. into an oxidation zone, can also be used.

In particular, the inlet 236 can have the form of a nozzle or pipe. the latter does not need to be perpendicular to the longitudinal axis of the cylindrical screw, as shown in the figure. Rather, the nozzle or the pipe can also enclose an acute angle with the longitudinal axis of the screw. As a result, the supplied gas can obtain a movement component in the conveying direction or else in the circumferential direction of the screw. While a movement component in the conveying direction counteracts a back-flow of the gas in the direction towards the filter device, a movement component in the circumferential direction can lead to a better mixing of the gas with the welding fume residues. Alternatively, an inlet can also be implemented by means of a porous portion of the wall of the screw pipe 239c or a porous insert in the wall of the screw pipe. For this purpose, the wall portion or insert can be configured as a microporous element, for example a gas-permeable sintered part, a metal fleece or metal grid.

As far as the embodiment of the screw helix 239b (that is to say of the screw thread) is concerned, it can be configured uniformly. However, it is also possible to vary the geometry of the screw helix along the conveying direction, meaning in particular to provide recesses in the flanks of the screw helix 239b or to vary the shape of the flanks of the screw helix 239b and/or to vary the flank angle. As a result, a better mixing of the welding fume residues can be ensured.

In particular, a first oxidizing agent sensor or oxygen sensor 240a and a second oxidizing agent sensor or oxygen sensor 240b can be seen in FIG. 8. Here, with reference to the path from the intake region 202 to the outlet 238, the first oxidizing agent sensor 240a is arranged closer to the intake region 202 than the second oxidizing agent sensor 240b. Preferably, when viewed in the conveying direction, the first oxidizing agent sensor 240a is arranged at the beginning of an oxidation zone and the second oxidizing agent sensor 240b is arranged at the end of the same or at a different oxidation zone. For example, paramagnetic sensors or lambda probes/Nernst probes can be used as sensors. As an alternative to the oxidizing agent concentration (in % by volume), for example an oxidizing agent partial pressure or else the total pressure in the conveying screw can also be detected.

While in FIG. 8 the two oxygen sensors 240a and 240b are shown seated directly on the wall of the screw pipe 239c, the sensors can of course also be arranged spaced apart from the wall of the screw pipe 239c, as is shown in FIG. 9. FIG. 9 is almost identical to FIG. 8. In the following, only the differences with respect to FIG. 8 will be described. First of all, the collecting container 74 is explicitly shown in FIG. 9. Furthermore, a supply pipe 236a for the oxidizing agent connected to the inlet 236 can be seen. In contrast to FIG. 8, the first oxidizing agent sensor 240a is not arranged close to the wall of the screw pipe 239c, but rather spaced apart therefrom on the supply pipe 236a, so that the oxidizing agent concentration in the gas stream supplied to the conveying screw can be measured.

Furthermore, a gas discharge line 238a, via which gas can be discharged from the conveying screw, can be seen in FIG. 9. Of course, however, the gas discharge line 238a does not necessarily have to be arranged at the collecting container 74, but could also be arranged at the wall of the screw pipe 239c, e.g. connected to the outlet 238. In contrast to FIG. 8, in FIG. 9 the second oxidizing agent sensor 240b is arranged at the gas outlet in order to be able to measure the oxidizing agent concentration in the gas discharge line. Assuming that no noticeable oxidation takes place any longer in the collecting container 74, the oxidizing agent concentration at two positions in the conveying screw spaced apart from one another in the conveying direction can also be detected by the arrangement of FIG. 9, namely at the position of the oxidizing agent inlet 236 and at the position of the outlet 238. In contrast to the setup of FIG. 8, however, the sensors 240a and 240b in FIG. 9 are not so strongly influenced by increased temperatures in the conveying screw due to their spacing from the conveying screw.

As already mentioned in the introduction, in the course of the additive manufacturing, welding fume can deposit as residue on the walls of the process chamber and of the pipe system existing for providing the protective gas atmosphere. Also these residues can be passivated by means of the described sensor-controlled oxidation. For this purpose, sensors for determining an oxygen concentration can be arranged in the process chamber 3 shown in FIG. 2 and/or in the gas supply channel 31 and/or the gas discharge channel 35 and/or at the gas inlet nozzle 32 and/or at the gas outlet nozzle 34 (FIGS. 1 and 2 show such an optionally present sensor 90 in the process chamber). If the shut-off valves 53 and 54 are closed, the space 3, 31, 32, 34 and 35 closed thereby can be used as chamber for a passivating oxidation. It is evident that in such a case a correspondingly designed control device has to be connected to the sensors and the shut-off valves 53 and 54 in order to control the process and in particular to control the time period within which the welding fume residues are exposed to the oxygen atmosphere.

As was also already mentioned in the introduction, the presence of oxidative materials such as, for example, oxygen in the process chamber during a manufacturing process is usually undesirable. If, however, after completion of a manufacturing process the manufactured object or the manufactured objects together with the building material have been removed from the process chamber 3, welding fume residues in the process chamber can be passivated by the sensor-controlled oxidation just described, so that afterwards the process chamber can be opened without danger and can be exposed to the ambient atmosphere.

Finally, it should also be noted that in the present application the term “number” is always used in the sense of “one or more”.

1. A method of oxidizing welding fume residues of an additive manufacturing apparatus adapted to process a metal-based building material,
wherein the additive manufacturing apparatus comprises a process chamber for manufacturing a three-dimensional object and
a circulation system having a gas circuit for a protective gas which is passed through the process chamber,
wherein the welding fume residues are exposed for a passivation time period to a gas atmosphere containing an oxidizing agent in a chamber, wherein the passivation time period is ended depending on a difference between oxidizing agent concentrations in the chamber detected by at least one sensor at two points in time having a predetermined distance from one another.

2. The method according to claim 1, wherein welding fume residues which have been filtered out of the protective gas by a filter element are oxidized.

3. The method according to claim 2, wherein the welding fume residues are exposed to the gas atmosphere containing the oxidizing agent together with the filter element.

4. The method according to claim 2, wherein the filter element can be cleaned by a gas pressure surge and welding fume residues that have been removed from the filter element by a cleaning process are exposed for the passivation time period to the gas atmosphere containing the oxidizing agent.

5. The method according to claim 4, wherein the welding fume residues are supplied to a waste container and the waste container and/or a volume arranged between the filter element and the waste container serves as a chamber in which the welding fume residues are exposed to the gas atmosphere containing the oxidizing agent.

6. (canceled)

7. A method of oxidizing welding fume residues of an additive manufacturing apparatus adapted to process a metal-based building material,
wherein the additive manufacturing apparatus comprises a process chamber for manufacturing a three-dimensional object and
a circulation system having a gas circuit for a protective gas which is passed through the process chamber,
wherein the welding fume residues are exposed to a gas atmosphere containing an oxidizing agent for a passivation time period in a conveying screw,
wherein oxidizing agent concentrations and/or oxidizing agent partial pressures at points in the conveying screw spaced apart from one another in the conveying direction are detected by at least two sensors.

8. The method according to claim 7, wherein the amount of the welding fume residues oxidized in the conveying screw and/or the amount of the welding fume residues present in the conveying screw is determined on the basis of the difference between the oxidizing agent concentrations determined by two sensors and/or on the basis of the difference between the oxidizing agent partial pressures determined by two sensors.

9. The method according to claim 1, wherein welding fume residues which have deposited in the process chamber or in a gas pipe system connected to the process chamber are exposed to the gas atmosphere containing the oxidizing agent in the process chamber or in the gas pipe system connected to the process chamber.

10. (canceled)

11. The method according to claim 1, wherein the passivation time period is ended when the difference between the oxidizing agent concentrations detected at two points in time at a predetermined distance from one another falls below a predetermined threshold value.

12. The method according to claim 1, wherein the passivation time period is ended when values of the oxidizing agent concentration of the gas atmosphere registered by the sensor within a predetermined reference time period differ from one another by an amount which lies within a predetermined fluctuation interval.

13. The method according to claim 1, wherein the two points in time at the predetermined distance from one another, with respect to which a difference between the detected oxidizing agent concentrations is determined, lie within an initial time period at the beginning of the passivation time period and the passivation time period is ended when, after the end of the initial time period, a difference between oxidizing agent concentrations detected at two points in time at the predetermined distance from one another is smaller by a predetermined percentage than the difference determined within the initial time period.

14. The method according to claim 1, wherein a time constant of an exponential decrease of the oxidizing agent concentration is determined on the basis of the difference between the oxidizing agent concentrations detected at two points in time having the predetermined distance from one another and the point in time of the end of the passivation time period is determined therefrom.

15. The method according to claim 1, wherein the oxidizing agent supply into the chamber is switched off before the detecting of the oxidizing agent concentration with the sensor.

16. The method according to claim 1, wherein the welding fume residues are exposed to the gas atmosphere containing the oxidizing agent in a temporarily gas-tight closed chamber.

17. (canceled)

18. An apparatus for oxidizing welding fume residues of an additive manufacturing apparatus adapted to process a metal-based building material,
wherein the additive manufacturing apparatus comprises a process chamber for manufacturing a three-dimensional object and
a circulation system having a gas circuit, the circulation system being adapted to pass a protective gas through the process chamber,
wherein the apparatus further comprises:
a chamber adapted to oxidize the welding fume residues, comprising a closable inlet for supplying a gas containing an oxidizing agent in order to provide for a gas atmosphere containing an oxidizing agent in the chamber,
at least one sensor for detecting an oxidizing agent concentration in the chamber and
a control device adapted to control a passivation time period in which the welding fume residues in the chamber are exposed to the gas atmosphere containing an oxidizing agent such that the passivation time period is ended depending on a difference between oxidizing agent concentrations in the chamber detected by the at least one sensor at two points in time having a predetermined distance from one another.

19. (canceled)

20. The apparatus according to claim 18, wherein the circulation system is connected to a filter system having at least two filter chambers, wherein each of the filter chambers contains at least one filter element for filtering particles in the protective gas stream and at least one openable and closable valve for gas-tight isolation of the filter chamber from the circulation system and wherein preferably at least one oxidizing agent sensor for detecting the oxidizing agent concentration of the gas atmosphere is arranged in the filter chamber,
wherein the control device is adapted to control openable and closable valves of the filter chambers such that in the filter chambers welding fume residues are filtered out of the protective gas and oxidized in the filter chambers alternately.

21. The apparatus according to claim 16, wherein the control device is adapted such that
in response to a request signal it isolates at least one of the filter chambers from the circulation system in order to supply the oxidizing agent to the at least one filter chamber and
the control device ensures that the protective gas stream flows through at least one filter chamber when a manufacturing process is taking place in the process chamber.

22. The apparatus according to claim 16, wherein the control device is adapted such that before supplying oxidizing agent to one of the filter chambers isolated from the circulation system it induces a cleaning of the filter element in this filter chamber by means of a gas pressure surge.

23. The apparatus according to claim 16, wherein protective gas from at least two additive manufacturing apparatuses is supplied to the filter system.

24. An apparatus for oxidizing welding fume residues of an additive manufacturing apparatus adapted to process a metal-based building material,
wherein the additive manufacturing apparatus comprises a process chamber for manufacturing a three-dimensional object and
a circulation system having a gas circuit, the circulation system being adapted to pass a protective gas through the process chamber,
wherein the apparatus further comprises:
a chamber adapted to oxidize the welding fume residues, comprising a closable inlet for supplying a gas containing an oxidizing agent in order to provide for a gas atmosphere containing an oxidizing agent in the chamber,
at least two sensors at the conveying screw for detecting oxidizing agent concentrations and/or oxidizing agent partial pressures at positions in the conveying screw spaced apart from one another in the conveying direction.

25. (canceled)
